(19) United States
(12) Patent Application Publication
(10) Pub. No.: US 2025/0174939 A1
(43) Pub. Date: May 29, 2025

(54) PLUG CONNECTOR

(71) Applicant: HARTING ELECTRIC STIFTUNG & CO. KG, Espelkamp (DE)

(72) Inventors: Sebastian THEISS, Tübingen (DE); Christian CORDING, Wagenfeld (DE); Felix LOSKE, Minden (DE); Joachim KRÄMER, Kirchlengern (DE)

(21) Appl. No.: 18/841,275

(22) PCT Filed: Feb. 9, 2023
(86) PCT No.: PCT/DE2023/100107

§ 371 Date: Aug. 23, 2024

(30) Foreign Application Priority Data
Feb. 28, 2022 (DE) 10 2022 104 736.9

(51) Int. Cl. H01R 13/631

(52) U.S. Cl. CPC H01R 13/631

(57) ABSTRACT

A plug connector having a first housing half and a second housing half is provided, wherein one or more contact elements are provided in each of the two housing halves, wherein the two housing halves can be transferred from a separated state into a connected state in order to establish an electrical contact of the contact elements and can be locked to one another in the connected state via a locking device. In order to specify a lockable plug connector that, in the connected state, has a surface that is as smooth as possible and easy to clean, the locking device is arranged completely inside the housing halves in the connected state of the housing halves.

### BACKGROUND

### Technical Field

The present disclosure relates to a plug connector.

Plug connectors are widespread and are employed in the field of the transmission of electric current and/or signal transmission. In this regard, plug connectors are needed in order to be able to connect one or more electrical leads, or an electrical lead and an electrical coupling-point provided on a device, to one another at points of connection, or to disconnect them.

Plug connectors consist of a plug part and a complementary socket part, which are pushed into one another for the purpose of establishing an electrical contact, and are pulled apart for the purpose of disengaging the contact. In the connected state (contact established), current or signals can be transmitted, whereas in the separated state the transmission is interrupted. The type, size, and structural design of the plug connectors ordinarily depend upon their respective field of application and upon the current or signals to be transmitted. There is frequently a requirement that the plug connector is able to be latched in the connected state, in order to guarantee a reliable contact and to prevent an inadvertent pulling apart of the parts of the plug connector, and also an automatic disengagement, for instance as a result of vibrational influences.

### Description of the Related Art

Many and various plug connectors that have a latching option are known from the prior art. For instance, the document DE 10 2004 008 719 A1 discloses a plug connector for contacting leads of a ribbon cable with external resilient latching levers which for the purpose of latching can be tensioned with elements on the exterior of the housing. A plug connector for optical waveguides is known from the document DE 10 2012 100 615 B4, in which detent hooks, which engage in corresponding detent grooves, are employed for the purpose of latching. The document EP 2 537 212 B1 presents a plug connector with external swiveling latching clips which interact with detent lugs for the purpose of latching.

In certain fields of application—for instance, in food technology or medical engineering—there is a requirement for surfaces that are as smooth and easy to clean or to disinfect as possible. However, plug connectors with latching devices ordinarily present an inconsistent surface, on which liquids, food residues and/or germs might be deposited at several places.

The German Patent and Trade Mark Office has searched the following prior art in the priority application relating to the present application: DE 10 2014 109 477 A1, DE 10 2020 206 186 A1, US 2013/0094811 A1 and US 2020/0169039 A1.

### BRIEF SUMMARY

Embodiments of the present disclosure provide a plug connector that is capable of being latched and that in the connected state exhibits a surface that is as smooth and easy to clean. This is achieved by a plug connector with a first and a second housing half, wherein one or more contact elements have been provided in each of the two housing halves, wherein the two housing halves are capable of being transferred from a separated state into a connected state for the purpose of establishing an electrical contact of the contact elements, and are capable of being latched to one another in the connected state with the aid of a latching device.

In accordance with the disclosure described herein, there is a provision that in the connected state of the housing halves, the latching device is arranged completely within the housing halves.

By virtue of the configuration of the plug connector, a smooth outer surface can be guaranteed in the latched state (plug connector closed, electrical contact established), since no parts of the latching device—for example, movable clips, rivets or closure lugs—have been provided on the outside of the plug connector. By this means, an easy-to-clean surface is made available. Any contact corrosion on external structural members is also avoided, since by virtue of the configuration of the plug connector no boundary surfaces with differing redox potential are present on the surface of the plug connector. The surface can, in addition, be coated if need be; for instance, a powder coating or a different kind of sealing of the entire housing can be applied.

According to an advantageous embodiment of the plug connector described herein, there may be a provision that the latching device is capable of being transferred from an open position into a latched position, each alternation between the two positions being effected by a compression movement executed on the two housing halves toward one another.

In this regard, according to this embodiment the present disclosure makes use of the mode of operation of so-called push-push mechanisms such as are known from the actuation of common ballpoint pens, for instance. In the domain of plug connectors, however, the use of such a mechanism has not been known hitherto.

Besides completely internal structural members, such push-push mechanisms offer the advantage, in addition, of the possibility of one-handed operation and small external dimensions of the plug connectors. This is because, due to the increased space requirement of an external latching device in conventional plug connectors, a correspondingly large spacing from surrounding components or other structural members has to be taken into account in the course of assembly. Consequently, plug connectors described herein with such push-push mechanisms are particularly well suited for sensitive regions with high contact densities, such as in medical engineering or food technology. On the other hand, vibrations such as predominate in industrial manufacturing plants, for instance, are less strongly pronounced in such fields of application, so the durability of a latching device actuated by a push-push mechanism is regarded as sufficient.

In one advantageous embodiment, the plug connector provides that at least one of the two housing halves includes at least one spring element, the spring force of which is directed contrary to the path of the compression movement.

The spring force enables a resetting of the internal mechanism after each compressive impulse of the push-push compression movement.

In concrete terms in this context, there may be a provision that the at least one spring element is in active communication with the contact element of the corresponding housing half.

In this embodiment, one contact element or both contact elements is/are resiliently supported by the spring element and provides/provide for the action of force directed contrary to the compression movement. The resilience can be realized, for example, by helical springs or other flexible elements such as, for example, leaf springs, resilient solid material, 3D printed springs consisting of lattice structures, etc.

According to one advantageous embodiment of the plug connector described herein, there may be a provision that at least one of the housing halves exhibits a locking device with which the housing halves are capable of being fixed in the latched position in such a manner that an implementation of the compression movement is prevented.

In this way, in its latched position the plug connector can be kept even more secure against external influences. Clasps, internal bolts, and latches enter into consideration, such as, by way of locking devices. To the extent that these devices are capable of being actuated from outside, they can be constructed in such a manner that they do not bring about a noticeable influence on the outer surface, so that the latter is still largely smooth.

In this context, there may be a provision that the locking device is capable of being actuated electrically.

Electromechanically movable retaining pins or bimetallic bolts enter into consideration by way of electrical actuating devices. In concrete terms in this regard, there may be a provision that the locking device is capable of being actuated electrically by a flow of current across the contact elements.

In this way, it can be ensured in an advantageous manner that a separation of the plug connector is prevented when a flow of current is present. In this regard, the flow of current brings about a holding energy, so to speak, for the locking device.

According to one embodiment of the plug connector, there may be a provision that one of the two housing halves exhibits by way of the latching device at least one retaining bolt which is movably guided in the housing half substantially perpendicular to the direction of the compression movement and is capable, when the compression movement is being implemented, of being moved from the open position into the latched position by an actuating element in such a manner that in the latched position it projects beyond a side wall of the housing half and interacts with the other housing half for the purpose of latching the two housing halves.

This design of the latching device is suitable in the case of housing halves that have been designed in such a manner that in the closed state of the plug connector, one of the two housing halves encloses the other. In this case, the actuating element can advantageously be moved by the push-push mechanism and can hold the retaining bolt in place, such as in the latched position. In this position, the retaining bolt projects beyond the side wall of the interior housing half and engages, for instance, in a correspondingly positioned slot of the exterior housing half, so that the two housing halves can no longer be separated from one another.

In this context there may be a provision that a return spring has been provided which counteracts the movement of the retaining bolt in the direction of the latched position.

In this case, the retaining bolt is acted upon by a return spring, in order that it slides back, propelled by the spring force, into the open position as soon as it is no longer held by the actuating element.

In concrete terms, there may be a provision, in addition, that the actuating element exhibits a beveled side interacting with the retaining bolt.

In this embodiment, the beveled side of the actuating element slides past the retaining bolt and presses it from the open position into the latched position by reason of the bevel. In the counter-movement, the actuating element releases the retaining bolt again correspondingly.

According to one embodiment, there may also be a provision that one of the housing halves exhibits by way of the latching device a pin which is arranged in such a manner that in the latched position it engages with a connecting link of the other housing half.

In this embodiment, the push-push mechanism which is present in one of the two housing halves exhibits a connecting link which catches with a pin, preferentially oriented at right angles to the direction of compression movement, in the other housing half, so that the latched state can be created. After another compression movement, the connecting link releases the pin again, so that the two housing halves can be separated from one another.

According to one embodiment, there may be a provision, in addition, that one of the housing halves exhibits by way of the latching device a movably supported lug which interacts with a guide channel in the other housing half when the compression movement is being implemented.

The lug is movably connected to one of the housing halves, for example is supported on a rotating bearing, and slides during the compression movement within the guide channel formed in the other housing half. In this way, an alternative type of push-push mechanism can be obtained. The lug passes through the guide channel with each compression movement, taking a different path on the way there than on the way back.

In concrete terms in this regard, there may be a provision that the contour of the guide channel is hook-shaped at least in some sections, so that when the compression movement is being implemented the lug is guided along the guide channel to a waypoint where it is fixed in the latched position.

The fixing waypoint is preferentially situated at the end of a hook-shaped path of the guide channel, which is passed through by the lug when the connection of the two housing halves is being established.

### BRIEF DESCRIPTION OF THE SEVERAL VIEWS OF THE DRAWINGS

Embodiments of the present disclosure are represented in the drawings and will be elucidated in more detail in the following:

FIG. 1 shows an embodiment of a plug connector;

FIG. 2 shows a sectional view of a plug connector;

FIG. 3 shows a first detailed view of a latching device of a plug connector;

FIG. 4 shows a second detailed view of a latching device of a plug connector;

FIG. 5 shows a detailed view of a housing half with latching slots;

FIG. 6 shows a first embodiment of a push-push mechanism;

FIG. 7 shows the push-push mechanism of FIG. 6 in the closed position;

FIG. 8 shows a detailed representation of a connecting link of the push-push mechanism of FIG. 6;

FIG. 9 shows a second embodiment of a push-push mechanism; and

FIG. 10 shows a plug connector with a locking device.

Some of the figures may contain simplified, schematic representations. In some cases, identical reference symbols are used for like but possibly not identical elements. Various views of like elements might have been scaled differently. Directional specifications such as, for instance, “left,” “right,” “at the top” and “at the bottom” are to be understood with reference to the respective figure and may vary in the individual representations in comparison with the object represented.

### DETAILED DESCRIPTION

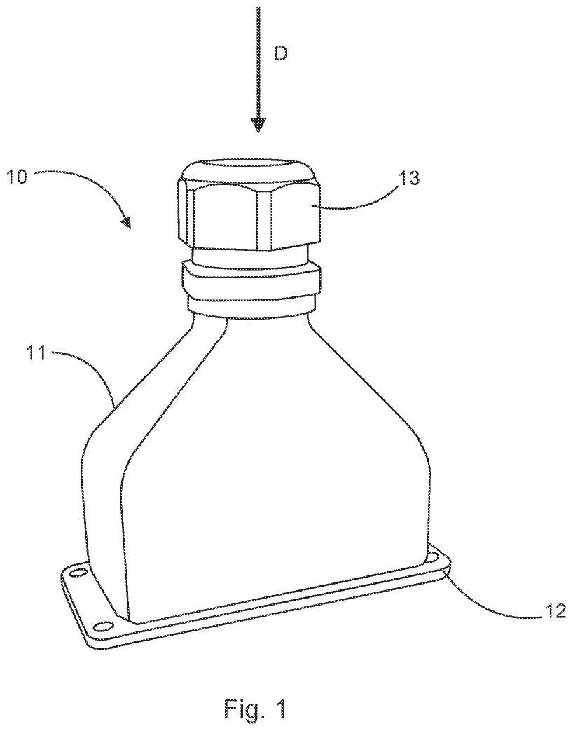

FIG. 1 shows an embodiment of a plug connector 10 in a closed state. The plug connector 10 comprises a first housing half 11 and a second housing half 12. In the embodiment shown in FIG. 1, the first housing half 11 takes the form of a cable plug which serves for electrical coupling of a cable (not shown in FIG. 1). For this purpose, the first housing half 11 exhibits a cable bushing 13 which is arranged, in merely exemplary manner, on an upper side of the first housing half 11. In the embodiment shown in FIG. 1, the second housing half 12 takes the form of a coupling flange which may have been arranged, for example, on the housing wall of an electrical appliance, of an appliance cabinet, or of an electrical installation, and may serve there for electrical coupling of electrical components to the cable of the first housing half. Alternatively, however, the second housing half 12 may also take the form of a cable socket. The assignment of the terms “plug” and “socket” in the embodiment shown in FIG. 1 is also to be regarded as merely exemplary and may, of course, also have been provided the other way around.

The plug connector 10 can be closed and opened again by a compression movement D executed in the direction of the arrow represented in FIG. 1. For this purpose, the plug connector 10 includes a latching device which in the closed state is completely internal (not shown in FIG. 1) and which by the compression movement D can be varied between a latched position and an open position. This novel closure mechanism is based on the so-called push-push principle, such as is known from cabinet doors or ballpoint pens, for example, but has not found application hitherto in the field of electrical plug connectors.

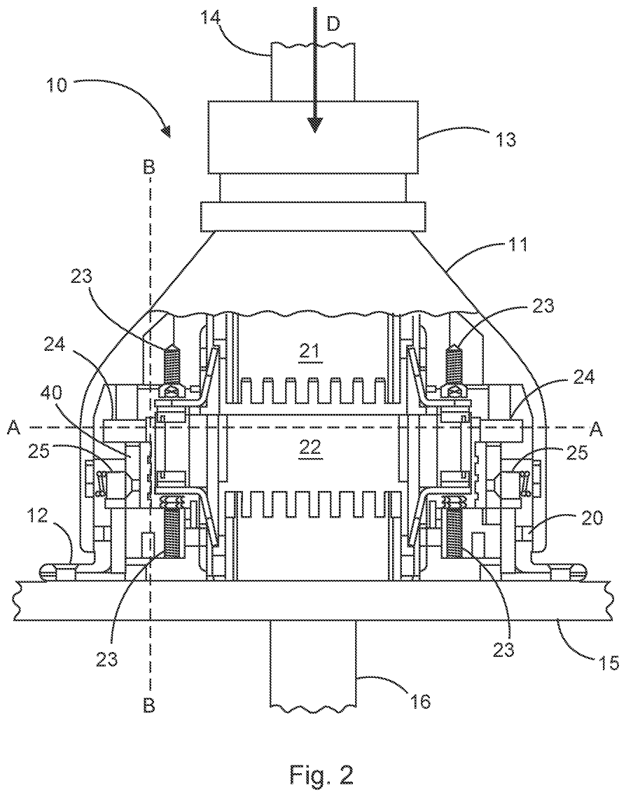

FIG. 2 shows a partial interior view of the plug connector 10. In addition, it is evident that the first housing half 11 has been coupled to a cable 14, whereas the second housing half 12 has been mounted on a housing wall 15 of an electrical installation. Electrical cable couplings 16 have been routed in the interior space of the electrical installation to the second housing half 12 taking the form of a coupling flange.

In addition, FIG. 2 shows that in the closed state of the plug connector 10 the first housing half 11 largely encloses the second housing half 12. For the purpose of sealing the plug connector against the ingress of liquids, a seal 20 may have been provided, which in the present case takes the form of an O-ring.

For the purpose of establishing an electrical connection, the first housing half 11 includes at least one first contact element 21 which in the closed state engages with at least one complementary contact element 22. The contact elements 21, 22 each consist of an insulating element, in the interior of which one or more metallic contact pins or contact sockets have been provided which bring about the electrical contact when the contact elements 21, 22 have been connected to one another. The contact elements 21, 22 are resiliently connected to the inside of the respective housing half 11, 12 via spring elements 23. The resilience can be realized, for example, by helical springs or other flexible elements such as, for example, leaf springs, resilient solid material, or 3D printed springs consisting of lattice structures. An alternative to the existing contact pins or contact sockets in the contact elements 21 and 22 is also possible, in which an integrated resilience (compare, for example, so-called pogo pins, abutting contacts or frontal-pressure contacts) has been provided. As a further alternative, a separate resilience of each individual contact pin within a respective insulating element may also have been provided. A combination of all the stated methods for resilient support is also possible.

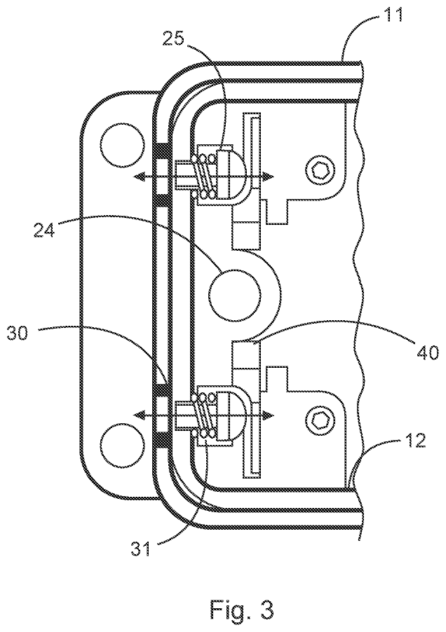

The plug connector 10 can be shifted from its closed state (electrical contact established) into its open state (electrical contact interrupted), and conversely, by repeated compression movements D. A push-push mechanism integrated into at least one of the housing halves 11, 12, on which the compression movement D is executed, serves for this purpose. The spring force generated by the spring elements 23 counteracts the compressive force. In the present embodiment, a push-push mechanism 24 is used in order to position a retaining bolt 25 in two detent positions differing from one another. The retaining bolt 25 is movably guided within the second housing half 12, being able to execute a movement that is oriented perpendicular to the direction of the compression movement D. In this context, FIG. 3 shows a detailed view that represents the mode of operation of the retaining bolt 25 in the sectional plane A-A of FIG. 2. In FIG. 3, the direction of motion of the retaining bolt 25 is indicated by a double-headed arrow.

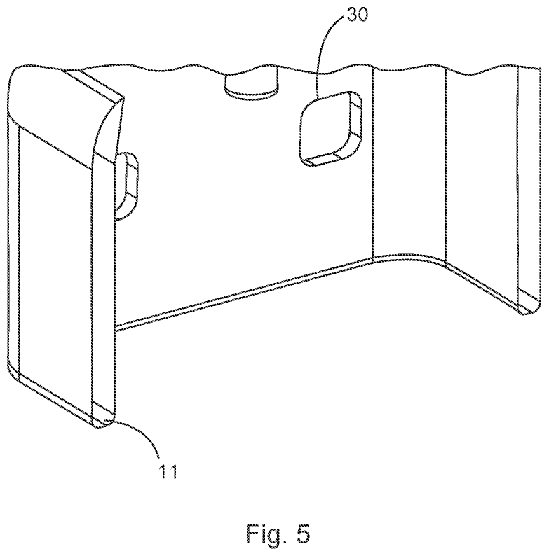

In the open position (shown in FIGS. 2 and 3), the retaining bolt 25 engages within the second housing half 12 in such a manner that the first housing half 11 can be guided past it in the course of plugging together. In the latched position, the retaining bolt 25 engages in a slot 30 matched to its geometry, which is formed in the first housing half 11 (in this regard, compare also the detailed view of FIG. 5), so that the two housing halves 11, 12 can no longer be separated from one another. For the purpose of returning the retaining bolt 25 into the open position, it is acted upon by a return spring 31 (compare FIG. 3).

In the latched position the two housing halves 11, 12 overlap by a certain amount. The gap between the two overlapping housing halves 11, 12 of the plug connector 10 can be closed by one or more O-ring seals 20 (compare FIG. 2). This seal 20 is additionally protected from direct external influences (for example, water, dust, dirt) by the overlapping of the two housing halves 11, 12, this having a positive effect on the impermeability, or the IP rating, of the plug connector 10.

The alternation between the two positions is affected by pressing the first housing half 11 against the second housing half 12 contrary to the spring force generated by the spring elements 23, and by the actuation, occurring thereby, of the push-push mechanism 24 integrated into the housing wall of the second housing half 12. The pushable path-length, necessary for this, between the first housing half 11 and the second housing half 12 is realized with the aid of the resilient support of the contact elements 21, 22. For instance, each contact element 21, 22 may have been supported so as to be capable of oscillating by at least half of the amount necessary for the triggering of the push-push mechanism 24.

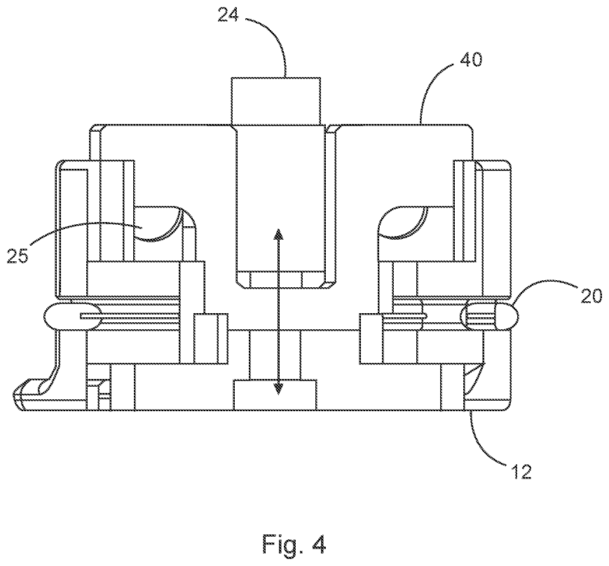

For the purpose of transmitting the motion of the push-push mechanism 24 to the retaining bolt 25, an actuating element 40 (compare also FIG. 4) has been provided which exhibits a beveled side which interacts with a rounded head of the retaining bolt 25. If the ramp realized by the beveled side slides down past the retaining bolt 25, the latter is pushed into the latched position. If the actuating element slides upward again by reason of the spring force of the spring elements 23, the retaining bolt is returned to the open position by reason of the restoring force of the return spring 31. FIG. 4 shows a detailed view of the actuating element 40 in section B-B of FIG. 2. The direction of motion of the actuating element is likewise indicated in FIG. 4.

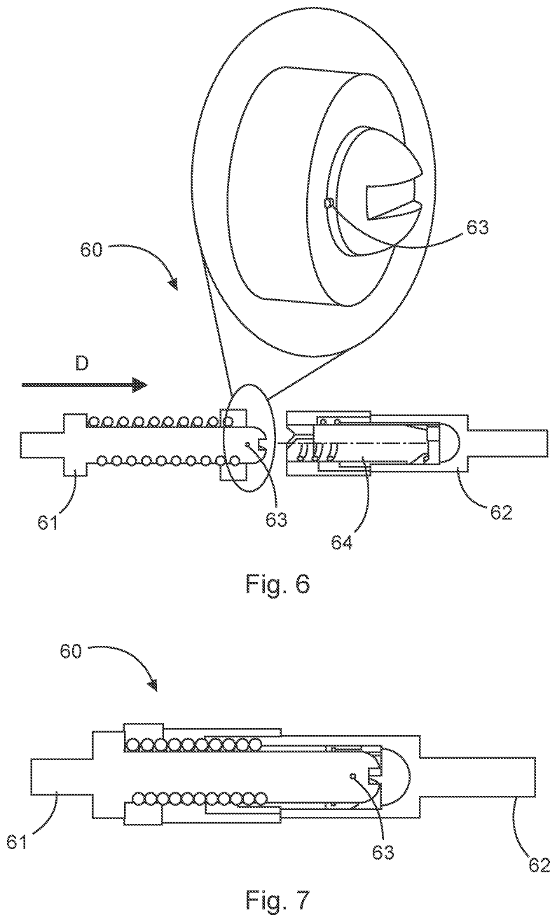

One possibility for constructing a push-push mechanism 24 with internal latching is indicated in FIGS. 6 to 8. In addition to this concrete embodiment, however, a realization of the push-push mechanism is also conceivable in any other way that enables the plug connector 10 to be opened and closed by repeated execution of the compression movement D.

FIG. 6 shows a push-push mechanism 60 with a spring-loaded plug 61 and with a spring-loaded socket 62 in the separated state. By virtue of a movement directed toward one another (indicated by an arrow in FIG. 6), the plug 61 and the socket 62 can be pushed into one another, in order to be transferred into the latched state. In this process, the springs are deflected out of their resting position. This corresponds to the execution of the compression movement D. For the purpose of holding the push-push mechanism in the latched position, the plug 61 exhibits a pin 63 arranged perpendicular to the direction of motion, which engages in a corresponding recess of a connecting link 64 contained in the socket 62. The connecting link 64 is rotatably held in the socket 62 and shaped in such a manner that it rotates by a certain angle (for example, 90°) with each implementation of the compression movement D. By virtue of the rotation, the pin 63 catches in the recess of the connecting link and is held in place in the latched state. By further rotating of the connecting link in the course of a repeated execution of the compression movement D, the pin 63 is released again from the connecting link 64, and the push-push mechanism is guided back again into the separated position by the spring force of the integrated springs.

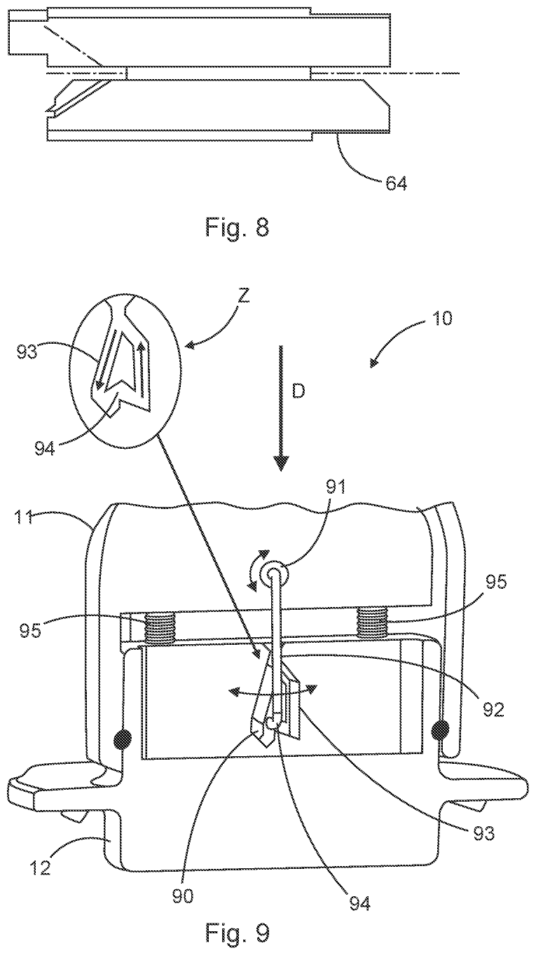

An alternative embodiment of a connecting link 64 is shown in FIG. 8. The connecting link 64 is shaped in such a manner that, on the one hand, the partial rotation with each push of the compression movement D is guaranteed and, on the other hand, the pin 63 can be held securely in the latched position.

In the embodiment shown here, spring elements for executing the push-push mechanism have already been integrated into the mechanism itself. These spring elements may be present in the housing halves according to FIG. 2 as an alternative to, or in addition to, the spring elements 23.

The push-push mechanism 60 shown in FIGS. 6 to 8 can, for instance, be integrated into the plug connector 10 in place of the push-push mechanism 24.

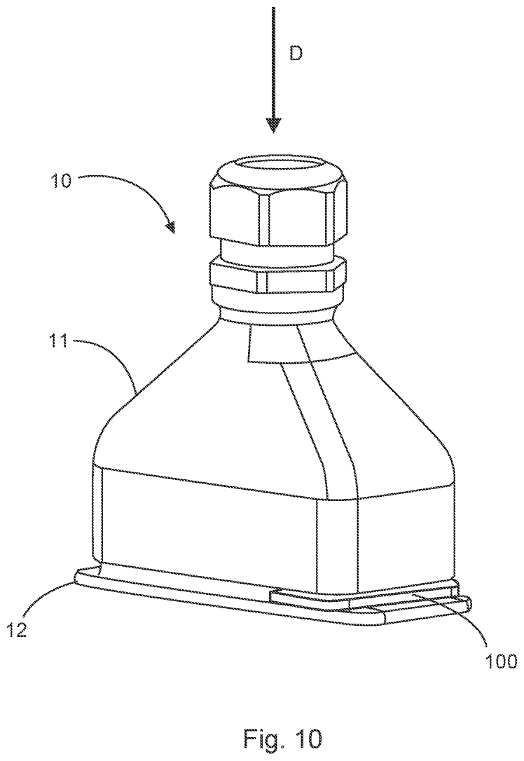

An alternative embodiment of a push-push mechanism with integrated latching function is shown in FIG. 9. FIG. 9 shows the plug connector 10 with the two housing halves 11, 12. From the first housing half 11, a lug 90 is held on an arm 92 which is supported so as to be capable of swiveling about a point of rotation 91. The lug 90 engages in a guide channel 93 which has been introduced in the second housing half 12 in the form of a slot. The shape of the guide channel 93 has been designed in such a manner that the lug passes through a different path along the guide channel 93 in the course of a movement executed in the direction of the compression movement D than in the course of a movement executed contrary to the compression movement (see also detailed partial representation Z of the guide channel 93 in FIG. 9). In addition, the guide channel 93 is at least partially hook-shaped and exhibits a waypoint 94 which holds the lug in place after it has passed through the first path in the latched position of the push-push mechanism by action of the return-spring force of spring elements 95. Only by a renewed compression movement D is the lug 90 released from the fixing of the waypoint 94, and it slides along the other path of the guide channel 93 into the open position.

The push-push mechanism shown in FIG. 9 can, for instance, be integrated into a side wall of the respective housing half 11,12 of the plug connector 10 in place of the push-push mechanism 24.

A secure locking of the push-push mechanism can be guaranteed by an additional locking device 100. This is indicated in FIG. 10. In the activated state, the locking device 100 blocks the execution of the compression movement D, so that the push-push mechanism cannot be triggered. Such a locking device 100 can be affected by the attachment of a securing latch which, in the closed state of the plug connector 10, is pushed between the second housing half 12 and the first housing half 11. As a result, the second push of the push-push mechanism is prevented, and the latching device—for example, the retaining bolt 25 (compare FIG. 2)—cannot be moved out of the latched position. A locking device 100 in the form of a securing latch can, for example, be attached to one or more sides of the plug connector 10 at existing mounting holes of the second housing half 12 without adversely affecting the uniform and smooth surface of the plug connector 10.

Alternative versions of the locking device 100 include, for example, rotary latches, sliding latches, spacing bolts in the interior of the housing, or clasps between the housing halves. The locking device 100 can be actuated manually or electrically. In the case of an electrically actuated locking device 100, electromechanical mechanisms or shape-memory alloys, for instance, enter into consideration. Such electrically activatable locking devices 100 can be triggered (locked) when the plug connector 10 is under electrical load (flow of current across the contact units), and can correspondingly be released again (unlocked) when no current is being transmitted (no flow of current across the contact units). This function guarantees that plugging and unplugging of the plug connector 10 under load is prevented.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A plug connector, comprising:
a first housing half; and
a second housing half, wherein one or more contact elements have been provided in each respective housing half, wherein the first and second housing halves are capable of being transferred from a separated state into a connected state for the purpose of establishing an electrical contact of the contact elements, and in the connected state are capable of being latched to one another with the aid of a latching device, and wherein in the connected state of the housing halves the latching device is arranged completely within the housing halves.

2. The plug connector as claimed in claim 1, wherein the latching device is capable of being transferred from an open position into a latched position, each alternation between the open position and the latched position being effected by a compression movement executed on the first and second housing halves toward one another.

3. The plug connector as claimed in claim 2, wherein at least one of the two housing halves includes at least one spring element, a spring force of the spring element of which is directed contrary to a path of the compression movement.

4. The plug connector as claimed in claim 3, wherein the at least one spring element is in active communication with the contact element of a corresponding housing half.

5. The plug connector as claimed in claim 2, wherein at least one of the housing halves exhibits a locking device with which the housing halves are capable of being fixed in the latched position in such a manner that an implementation of the compression movement is prevented.

6. The plug connector as claimed in claim 5, wherein the locking device is capable of being actuated electrically.

7. The plug connector as claimed in claim 6, wherein the locking device is capable of being actuated electrically by a flow of current across the contact elements.

8. The plug connector as claimed in claim 2, wherein one of the two housing halves exhibits by way of the latching device at least one retaining bolt movably guided in the housing half substantially perpendicular to the direction of the compression movement and is capable, when the compression movement is being implemented, of being moved from the open position into the latched position by an actuating element in such a manner that in the latched position the actuating element projects beyond a side wall of the housing half and interacts with the other housing half for the purpose of latching the two housing halves.

9. The plug connector as claimed in claim 8, wherein a return spring counteracts the movement of the at least one retaining bolt in a direction of the latched position.

10. The plug connector as claimed in claim 8, wherein the actuating element exhibits a beveled side interacting with the at least one retaining bolt.

11. The plug connector as claimed in claim 2, wherein one of the housing halves exhibits by way of the latching device a pin arranged in such a manner that in the latched position the pin engages with a connecting link of the other housing half.

12. The plug connector as claimed in claim 2, wherein one of the housing halves exhibits by way of the latching device a movably supported lug which interacts with a guide channel in the other housing half when the compression movement is being implemented.

13. The plug connector as claimed in claim 12, wherein a contour of the guide channel is hook-shaped at least in some sections, so that when the compression movement is being implemented the lug is guided along the guide channel to a waypoint where the lug is fixed in the latched position.
